(19) United States
(12) Patent Application Publication
(10) Pub. No.: US 2024/0385018 A1
(43) Pub. Date: Nov. 21, 2024

(54) Method for Surface Treatment of Measuring Electrodes Inserted into a Measuring Tube for Magnetic-Inductive Flowmeters

(71) Applicant: Krohne AG, Basel (CH)

(72) Inventors: Arthur den Haan, Leiden (NL); Antwan Rejnen, Den Haag (NL)

(21) Appl. No.: 18/666,161

(22) Filed: May 16, 2024

(30) Foreign Application Priority Data
May 19, 2023 (DE) 10 2023 113 189.3

(51) Int. Cl. G01F 1/58

(52) U.S. Cl. CPC G01F 1/584

(57) ABSTRACT

A method for the surface treatment of measuring electrodes inserted into a measuring tube for magnetic-inductive flowmeters is disclosed. The measuring electrodes have at least a carrier material of poor electrical conductivity and a conductive material of good electrical conductivity embedded in the carrier material, so that the measuring electrodes as a whole have an overall electrical conductivity suitable for the measuring task of the magnetic-inductive flowmeter. The method includes irradiating surface regions of the measuring electrodes terminating with an inner wall of the measuring tube with at least one laser beam. The irradiating step involves at least partially removing a carrier material in the surface regions of the measuring electrodes. The irradiating step also involves at least partially exposing an embedded electrically highly conductive material in the surface regions of the measuring electrodes and increasing the electrical surface conductivity of the measuring electrodes.

### TECHNICAL FIELD

The invention relates to a method for the surface treatment of measuring electrodes inserted into a measuring tube for magnetic-inductive flowmeters, wherein the measuring electrodes have at least a carrier material with poor electrical conductivity and a conductive material with good electrical conductivity embedded in the carrier material, so that the measuring electrodes as a whole have an overall electrical conductivity suitable for the measuring task of the magnetic-inductive flowmeter.

### BACKGROUND

The measuring principle of magnetic-inductive flowmeters is based on the action of force on moving charges in a magnetic field when the direction of movement of the charge carriers has a component perpendicular to the magnetic field. Separate charge carriers of different signs induce a voltage in the medium flowing through the measuring tube that is substantially proportional to the flow rate of the medium in the measuring tube, so that the volumetric flow rate in the measuring tube can be inferred.

The induced voltage is detected by the aforementioned measuring electrodes, which in the present case must have a certain electrical conductivity as a prerequisite. The measuring tube itself is either made of or lined with an electrically non-conductive material, such as polyetheretherketone (PEEK).

The measuring electrodes inserted into the measuring tube are at least formed from a carrier material with poor electrical conductivity and a conductive material with good electrical conductivity embedded in the carrier material, which gives the measuring electrodes an overall electrical conductivity suitable for measurement. Such measuring electrodes are manufactured, for example, by injection molding. The measuring electrodes often initially have reduced surface electrical conductivity in the surface area because the conductive material embedded in the carrier material is largely covered by the carrier material, so that the conductive material has only a small surface area in the surface area.

To increase the surface conductivity of the measuring electrodes, it is known to treat the surface area of the measuring electrodes, for example by means of mechanical spray processes. In this process, abrasive particles are accelerated in a gas stream and the resulting gas-particle jet is directed onto the surface areas of the measuring electrodes, roughening the surface and exposing conductive material in the surface area. This approach has the disadvantage that the substrate and/or the conductive material in the surface region is often structurally damaged. If the conductive material is formed by electrically conductive carbon fibers, for example, these can be damaged by the spray process, so that the achievable surface conductivity is reduced or the surface conductivity of the measuring electrodes can change during operation because damaged conductive material detaches in the medium flow or because the damaged surface has an increased tendency to adhere.

### SUMMARY

The object of the present invention is thus to provide a method for the surface treatment of measuring electrodes inserted into a measuring tube for magnetic-inductive flowmeters, in which the disadvantages described above are avoided or at least reduced.

The method according to the invention, with which the previously derived object is achieved, is essentially characterized in that the surfaces of the measuring electrodes terminating with the inner wall of the measuring tube are irradiated with at least one laser beam, that thereby the carrier material in the surface region of the measuring electrodes is at least partially removed and thereby the embedded electrically highly conductive conductive material in the surface region of the measuring electrodes is at least partially exposed and the electrical surface conductivity of the measuring electrodes is increased.

It has been shown that laser beams are, in principle, suitable for treating the surface region of the measuring electrodes presupposed here in such a way that the surface conductivity of the measuring electrodes is increased, and without the measuring electrodes in the surface region being damaged in such a way as is known from the prior art.

According to a preferred design of the method, the laser beam is directed at the surface of the measuring electrodes at a shallow angle, in particular at an angle of more than 75° (angular degree, with a full angle of 360°) to the surface normal of the surface of the measuring electrodes, specifically an even shallower angle is used, namely of more than 83° to the surface normal of the surface of the measuring electrodes, i.e. of less than 7° to the measuring tube surface or to the surface of the measuring electrodes. Surprisingly, this allows excellent surface results to be obtained with significant exposure of the conductive material. This is possibly due to the fact that the energy input of the laser beam into the surface of the measuring electrodes can be easily adjusted via the flat angle.

Preferably, the wavelength of the laser beam is selected so that the photon energy overcomes the molecular binding forces of the substrate material and releases the substrate material upon irradiation. Preferably, the carrier material is combined with a guide material whose molecular binding forces are greater than those of the carrier material. In this case, the wavelength of the laser beam is additionally selected so that the photon energy does not overcome the molecular binding forces of the guide material and does not release the guide material.

Preferably, the laser beam is adjusted so that it has a maximum diameter of 100 μm in the area of impact on the surface of the measuring electrodes; preferably, the laser beam has a maximum diameter of 20 μm in the area of impact. The diameter of the laser beam in the area of impact is thus considerably smaller than the diameter of conventional measuring electrodes or of the surface area of the measuring electrodes via which the medium located in the interior of the measuring tube is contacted in the operating state of the magnetic-inductive flowmeter.

In a preferred design of the method, the laser beam is guided in straight lines over the surfaces of the measuring electrodes, preferably in straight parallel lines. Preferably, the laser beam also sweeps over the transition regions between the measuring electrodes and the measuring tube in which the measuring electrodes are inserted.

A further development of the method is characterized in that the laser beam is pulsed, in particular with a pulse duration in the range of less than 50 femtoseconds, particularly preferably in the range of less than 10 femtoseconds. It has been found that the high peak powers of the laser pulses are particularly advantageous for the removal of many substrate materials.

In a particularly preferred further development of the method, it is provided that the wavelength of the laser beam and/or the pulse duration of the laser beam and/or the speed of movement of the laser beam are selected or adapted to one another in such a way that the removed substrate material and/or the removed conductive material does not deposit on the surface of the measuring electrodes.

A further preferred design of the method is characterized in that the wavelength of the laser beam and/or the pulse duration of the laser beam and/or the speed of movement of the laser beam are selected or adapted to one another in such a way that at least the carrier material remaining on the measuring electrode is not chemically changed, in particular wherein the exposed conductive material is also not chemically and/or structurally changed. In particular, it should be avoided that the molecular structure of the carrier material is changed or that molecules of the carrier material enter into compounds with other substances (for example oxygen). As various test series have shown, such a tuning of the parameters is readily possible, which is precisely the advantage over the known mechanically abrasive treatment processes. The inspection for structural changes can be carried out, for example, with a scanning electron microscope.

Preferably, a gas flows through the measuring tube during irradiation of the surfaces of the measuring electrodes with the laser beam, wherein the gas carries away the material removed by the measuring electrodes. It is particularly preferable that the gas is as inert as possible, i.e. an inert gas. Preferably, nitrogen is used, which has been shown to be sufficiently inert.

The method is preferably used for measuring electrodes in which the substrate material is polyetheretherketone (PEEK), in particular when electrically conductive carbon fibers are used as the conductive material. In this context, a wavelength in the range of 355 nm and 500 nm is preferably selected for the laser beam, in particular in the range of 355 nm and 380 nm, since the energy absorption of PEEK is very high here.

In a further development of the method, it is provided that the impedance of the surface-treated measuring electrodes is measured in a checking step and the parameters wavelength of the laser beam and/or pulse duration of the laser beam and/or speed of movement of the laser beam are selected or adapted in such a way that a predetermined impedance of the surface-treated measuring electrodes is achieved. Preferably, the checking step is performed in the production process after a batch change of the substrate material and/or the conductive material.

### BRIEF DESCRIPTION OF THE DRAWINGS

In detail, there are now a multitude of possibilities for designing and further developing the method according to the invention for the surface treatment of measuring electrodes inserted into a measuring tube for magnetic-inductive flowmeters. For this purpose, reference is made to the following description of embodiments in connection with the drawings.

FIG. 1 illustrates a measuring tube of a magnetic-inductive flowmeter with inserted measuring electrodes.

FIG. 2 illustrates an image of the surface area of a measuring electrode inserted into the measuring tube of a magnetic-inductive flowmeter.

FIG. 3 illustrates an electron microscope image of the surface area of a measuring electrode that has been processed using a spraying method.

FIG. 4 schematically illustrates the method according to the invention for the surface treatment of measuring electrodes inserted in a measuring tube for magnetic-inductive flowmeters.

FIG. 5 illustrates the measuring tube of a magnetic-inductive flowmeter with inserted measuring electrodes and indicated treatment by a laser beam.

FIG. 6 schematically illustrates the processing sequence of the surface area of a measuring electrode with a laser beam.

FIG. 7 illustrates an electron microscope image of the surface area of a measuring electrode processed with a laser beam.

### DETAILED DESCRIPTION

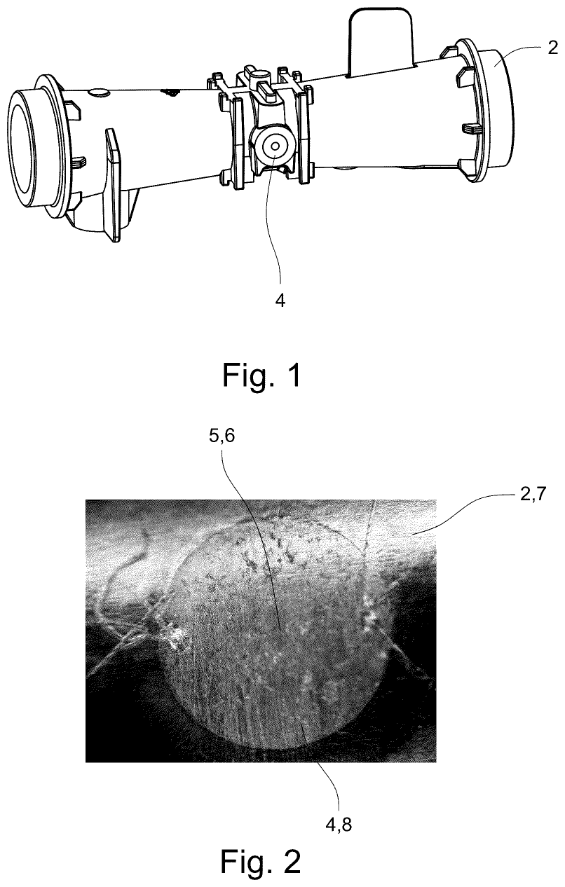

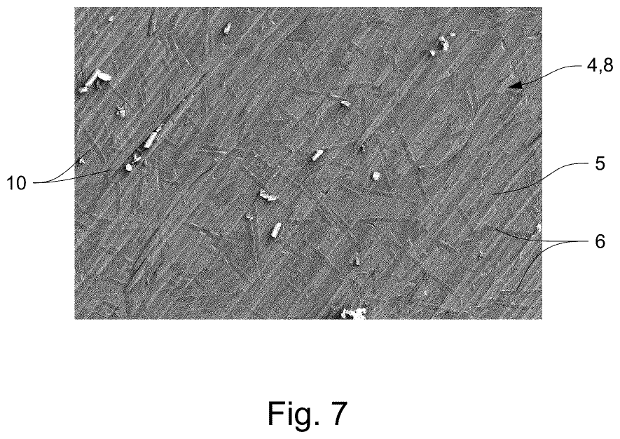

FIGS. 1 to 7 show various aspects of a method 1 for the surface treatment of measuring electrodes 4 inserted into a measuring tube 2 for magnetic-inductive flowmeters. The measuring tube 2 itself is made of glass fiber-reinforced polyetheretherketone (PEEK), which is electrically non-conductive. The components otherwise still required for operating a magnetic-inductive flowmeter, such as a magnetic field device that generates a magnetic field in the interior of the measuring tube 2 in the area of the measuring electrodes 4, are intentionally not shown here for reasons of clarity.

The measuring electrodes 4 have an overall electrical conductivity that makes it possible to perform the measurement task, namely to record a voltage induced in the medium flowing through the measuring tube 2 during operation of the magnetic-inductive flowmeter as the actual measurement variable of interest. The measuring electrodes 4 are therefore arranged in recesses of the measuring tube 2—for example in bores—or are also produced there first (injection molding), wherein in each case a surface region 8 of the measuring electrodes 4 terminates with the inner wall 7 of the measuring tube 2. The inner wall 7 of the measuring tube 2 and the surface area 8 of the measuring electrodes 4 form a largely flat and mechanically seamless overall surface, which leads to practically no disturbance in terms of flow.

FIG. 2 shows a close-up view of the surface area 8 of the measuring electrode 4, which has an almost circular cross-section. The surface area 8 of the measuring electrode 4 and the surface of the inner wall 7 of the measuring tube 2 merge practically seamlessly into one another; a clearly defined boundary between the areas can only be discerned visually.

Common to all measuring electrodes 4 shown here is that the measuring electrodes 4 have at least one electrically poorly conductive carrier material 5, which in the present examples is polyetheretherketone (PEEK), and further have an electrically well conductive material 6 embedded in the carrier material 5, which in the cases shown is carbon fibers. The carbon fibers are present in the measuring electrodes 4 in such an amount that, as a result, the measuring electrodes 4 have an overall electrical conductivity suitable for the measuring task of the magnetic-inductive flowmeter.

The measuring electrodes 4 shown here have been manufactured by an injection molding process. FIG. 2 shows the untreated surfaces 8 after the measuring electrodes 4 have been inserted into the wall of the measuring tube 2. The surface area 8 of the measuring electrodes 4 has reduced surface electrical conductivity, since the highly conductive conductive material 6 in the form of carbon fibers in the surface area 8 of the measuring electrodes 4 is practically buried in the carrier material 5 and the conductive material 6 in the form of the carbon fibers is largely covered by the carrier material 5. In the prior art, it is therefore known to subject the surface region 8 of the measuring electrodes 4 to a surface treatment, for example by a mechanical spraying process, in order to expose the conductive material 6 in the surface region 8 of the measuring electrodes 4.

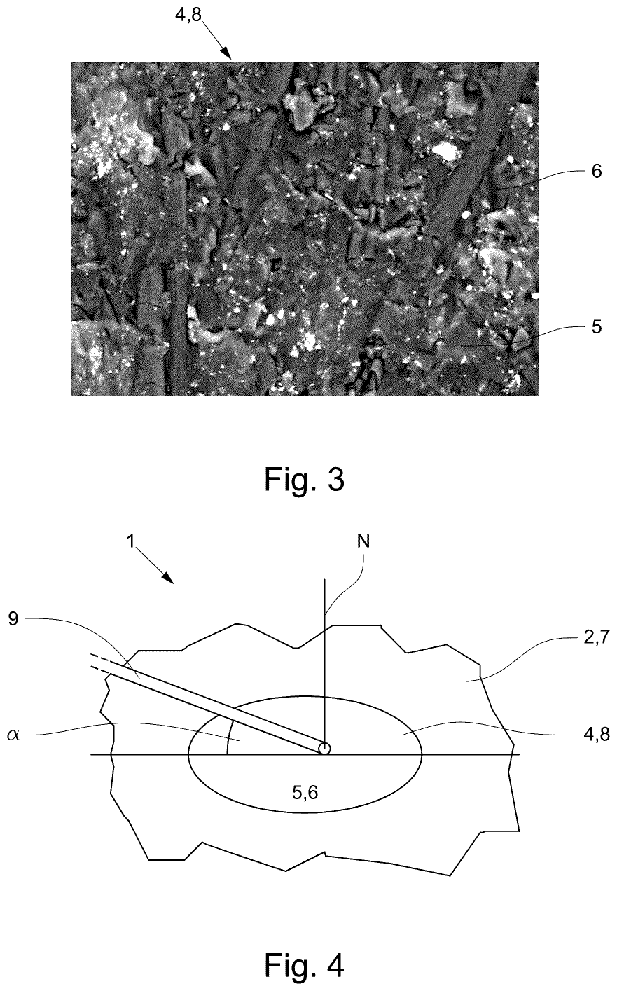

FIG. 3 shows the result of such a spraying treatment with electrocorundum. It can be seen that the carbon fibers forming the conductive material 6 are partially exposed, but structurally the fibers have been severely affected, they are splintered, broken and deformed. The support material 5 is also structurally compromised, exhibiting cracks and severe unevenness. As a result, the support material's 5 ability to hold the carbon fibers 6 embedded in it is significantly limited. Overall, the spraying process is difficult to control and the surface area 8 of the measuring electrodes 4 is always in danger of becoming severely damaged and unstable.

FIG. 4 shows the method 1 according to the invention for the surface treatment of measuring electrodes 4. The method 1 is characterized by the fact that the surface areas 8 of the measuring electrodes 4 terminating with the inner wall 7 of the measuring tube 2 are irradiated with a laser beam 9. As a result, the carrier material 5 in the surface region 8 of the measuring electrodes 4 is at least partially removed, so that the embedded conductive material 6 with good electrical conductivity is thereby at least partially exposed in the surface region 8 of the measuring electrodes 4, whereby the electrical surface conductivity of the measuring electrodes 4 is increased. With the method, the previously described disadvantages of using a mechanical spraying method can be avoided to a large extent.

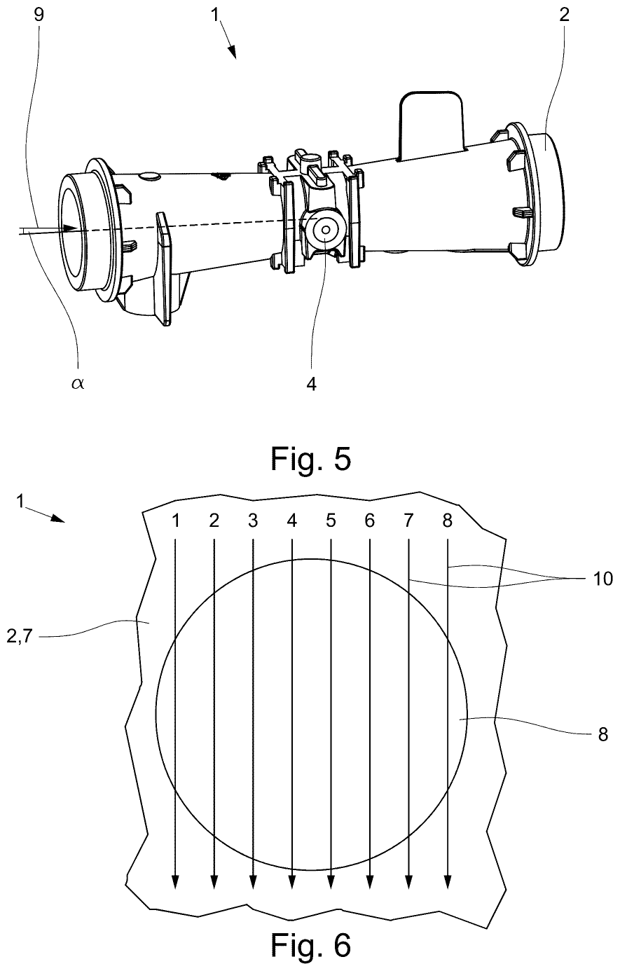

It has been found to be advantageous if the laser beam 9 is directed at a shallow angle onto the surface areas 8 of the measuring electrodes 4, as is also indicated in FIGS. 4 and 5. The surface results obtained are advantageously different from results obtained with steep angles of incidence, i.e., in the range of the surface normals N of the surface areas 8.

In the embodiments shown, the wavelength of the laser beam 9 is selected such that the photon energy overcomes the molecular binding forces of the substrate 5 and releases the substrate 5. The laser beam 9 used here is pulsed with a pulse duration in the range of a few femtoseconds. This makes it possible to achieve very high, but at the same time very brief, energy inputs, which are advantageous for the effect sought here. In the area of impact on the surface 8 of the measuring electrodes 4, the laser beam 9 has a maximum diameter of 20 micrometers, so the surface area 8 of the measuring electrodes 4 is not irradiated over the entire surface, but quite the opposite, only in a very small section. As a result, the surface area 8 of the measuring electrodes 4 must be scanned with the laser beam 9 in order to implement the surface treatment for a correspondingly large part of the surface area 8.

FIG. 6 shows that the laser beam 9 is guided, for example, in straight parallel lines 10 over the surface area 8 of the measuring electrodes 4. If the parallel lines 10 are spaced apart from each other, then a groove pattern with alternating valleys and heights is formed after the laser beam 9 has traversed the lines 10. In order not to place too great a thermal load on the material in the surface area 8 of the measuring electrodes 4, it is advisable not to produce adjacent lines 10 one after the other in time, but to skip adjacent lines 10 first. In FIG. 6, the processing sequence is indicated by the numbers 1 to 8.

FIG. 5 shows that the flat angle of incidence a (with respect to the surface 8 of the measuring electrode 4) also allows the surface treatment to be applied without difficulty even in narrow measuring tube geometries.

The parallel lines 10 in FIG. 6 are intentionally extended beyond the surface area 8 of the measuring electrodes 4, i.e. to the area of the inner wall 7 of the measuring tube 2. Furthermore, the straight lines 10 run in the direction of flow of the medium during operation of the magnetic-inductive flowmeter.

In the embodiments shown, the wavelength of the laser beam 9, the pulse duration of the laser beam 9 and the speed of movement of the laser beam 9 are adapted to each other in such a way that the substrate material 5 remaining on the measuring electrode 4 is not chemically changed, in particular, therefore, the molecular structure is not damaged. The same also applies to the exposed conductive material 6, which in this respect is also not altered by the surface treatment.

Within certain limits, the choice of the aforementioned parameters (wavelength of the laser beam 9, pulse duration of the laser beam 9, speed of movement of the laser beam 9) can also influence whether the removed substrate material 5 and/or any removed conductive material 6 is deposited again in the surface region 8 of the measuring electrodes 4. The choice of parameters is limited here, however, since the parameters are set primarily according to achieving optimum removal results. In order to prevent the deposition of re-moved carrier material 5 or removed conductive material 6, a gas flows through the measuring tube 2 during irradiation with the laser beam 9; nitrogen is used here.

For the constellation in which the substrate 5 is polyetheretherketone and the conductive material 6 is electrically conductive carbon fibers, a wavelength range of 355 nm to 380 nm has proved suitable for the laser beam 9.

The method 1 has a very high and stable repeatability, also with regard to the achieved overall conductivity of the measuring electrodes 4. Presently, the impedance of the surface-treated measuring electrodes 4 is measured in a checking step and the aforementioned parameters wavelength of the laser beam 9, pulse duration of the laser beam 9 and speed of movement of the laser beam 9 are adapted to each other in such a way that a desired predetermined impedance of the surface-treated measuring electrodes 4 is achieved. This checking step is repeated in particular if a batch change occurs in the production process with the carrier material 5 and/or with the conductive material 6. In an alternative design of the method, the impedance of a medium/surface interface of the surface-treated measuring electrodes 4 is measured in the checking step and compared with a predetermined impedance of the medium/surface interface of the surface-treated measuring electrodes 4.

1. A method for the surface treatment of measuring electrodes inserted into a measuring tube for magnetic-inductive flowmeters, wherein the measuring electrodes have at least a carrier material of poor electrical conductivity and a conductive material of high electrical conductivity embedded in the carrier material, so that the measuring electrodes as a whole have an overall electrical conductivity suitable for the measuring task of the magnetic-inductive flowmeter, the method comprising:
irradiating surface regions of the measuring electrodes terminating with an inner wall of the measuring tube with at least one laser beam;
wherein the irradiating step involves at least partially removing the carrier material in the surface regions of the measuring electrodes; and
wherein the irradiating step involves at least partially exposing the embedded conductive material in the surface regions of the measuring electrodes and increasing the electrical surface conductivity of the measuring electrodes.

2. The method according to claim 1, characterized wherein the laser beam is directed onto the surface regions of the measuring electrodes at an angle of more than 75° to the surface normal of the surface regions of the measuring electrodes.

3. The method according to claim 1, wherein a wavelength of the laser beam is selected such that the photon energy overcomes the molecular binding forces of the carrier material and releases the carrier material.

4. The method according to claim 1, wherein the laser beam is pulsed with a pulse duration in the range of less than 50 femtoseconds.

5. The method according to claim 1, wherein the laser beam in the impact area on the surface of the measuring electrodes has a maximum diameter that is less than or equal to 100 μm.

6. The method according to claim 1, wherein the laser beam is guided in straight parallel lines over the surface regions of the measuring electrodes.

7. The method according to claim 6, characterized wherein the straight parallel lines are produced in a direction of flow of a medium through the measuring tube.

8. The method according to claim 1, wherein at least one of a wavelength of the laser beam, a pulse duration of the laser beam, and a speed of movement of the laser beam are adapted to one another in such a way that at least the carrier material remaining on the measuring electrode is not chemically changed, and the exposed conductive material is not chemically and/or structurally changed.

9. The method according to claim 1, wherein at least one of a wavelength of the laser beam, a pulse duration of the laser beam, and a speed of movement of the laser beam are adapted to one another in such a way that at least one of the removed carrier material and the removed conductive material are not deposited in the surface regions of the measuring electrodes.

10. The method according to claim 1, wherein an inert gas flows through the measuring tube during irradiation with the laser beam; and
wherein the inert gas carries away the material removed from the measuring electrodes.

11. The method according to claim 1, wherein polyetheretherketone (Peek) is selected as the substrate; and
wherein electrically conductive carbon fibers are selected as the conducting material.

12. The method according to claim 11,
wherein the wavelength of the laser beam is selected in the range of 355 nm and 500 nm.

13. The method according to claim 1, wherein, after the irradiating step, an impedance of a medium/surface interface of the measuring electrodes, is measured in a checking step;
wherein at least one of a wavelength of the laser beam and/or, a pulse duration of the laser beam, and a speed of movement of the laser beam are selected in such a way that a predetermined impedance of the medium/surface interface of the surface-treated measuring electrodes, is achieved during the irradiating step; and
wherein the checking step is performed in the production process after a batch change of at least one of the carrier material and/or the conductive material.

14. The method according to claim 1, wherein the laser beam is guided in straight parallel lines over the surface regions of the measuring electrodes; and
wherein the straight parallel lines form a groove pattern with alternating valleys and heights.

15. The method according to claim 14, wherein, in the production of the groove pattern, adjacent lines of the straight parallel lines are not produced one after the other in time.
